(19) United States
(12) Patent Application Publication
(10) Pub. No.: US 2017/0327072 A1
(43) Pub. Date: Nov. 16, 2017

(54) VEHICLE AIRBAG PANEL AND METHOD FOR PRODUCING SAME

(71) Applicant: LEAR CORPORATION, Southfield, MI (US)

(72) Inventors: Paul S. SEVERINSKI, Brownstown, MI (US); Louella Ann PATTERSON, Goodells, MI (US); Thomas A. WELCH, SR., Ortonville, MI (US); Lisa TOWNLEY, Allen Park, MI (US); Pusheng CHEN, Novi, MI (US); David GALLAGHER, Sterling Heights, MI (US)

(21) Appl. No.: 15/155,774

(22) Filed: May 16, 2016

(51) Int. Cl. B60R 21/2165; B60R 13/02; B60R 21/16

(52) U.S. Cl. CPC B60R 21/2165; B60R 13/02; B60R 2021/161; B60R 2013/0287

(57) ABSTRACT

An airbag panel for a vehicle airbag system having an inflatable airbag and an inflator operable to inflate the airbag includes a first edge configured to be attached to a trim material in a vehicle interior along a first length to form a seam. A second edge may be configured to be attached to the first edge and the trim material along a second length, and at least one force-concentrating feature associated with at least one of the first edge or the second edge may be configured to effect application of a first force to a first portion of the seam and a second force less than the first force to a second portion of the seam when an inflating airbag contacts the seam.

### TECHNICAL FIELD

The present disclosure relates to an airbag panel for a vehicle and a method for producing such an airbag panel.

### BACKGROUND

Vehicle airbag systems, which often deploy through a seam in trim materials inside the vehicle, require a design balance between creating a seam in the trim material that is weak enough for the airbag to deploy properly, but not so weak that it fails to maintain its integrity during normal wear and tear on the trim material. This may be particularly true where the airbag system is installed in a vehicle seat, where the trim material may be stressed each time a vehicle occupant sits into or moves around in the seat. It would therefore be desirable to have an airbag system that included one or more elements designed to allow a robust tear seam in the trim material that maintains its integrity during normal use, but which tears readily to allow proper deployment of the airbag during a deployment event.

### SUMMARY

At least some embodiments of the present invention may include an airbag panel for a vehicle airbag system having an inflatable airbag and an inflator operable to inflate the airbag. The airbag panel may include a first portion including a first edge configured to be attached to a trim material of the vehicle to form a seam. A second portion may include a second edge configured to be attached to the first edge and the trim material along at least a portion of the seam. Also included may be a force-concentrating feature that causes a greater force to be applied to a first section of the seam than is applied to a second section of the seam when the first and second portions are attached to each other, are disposed around at least a portion of an airbag, and an inflator is activated to inflate the airbag.

At least some embodiments of the present invention may include an airbag panel for a vehicle airbag system having an inflatable airbag and an inflator operable to inflate the airbag. The airbag panel may include a first edge configured to be attached to a trim material in a vehicle interior along a first length to form a seam. A second edge may be configured to be attached to the first edge and the trim material along a second length, and at least one force-concentrating feature associated with at least one of the first edge or the second edge may be configured to effect application of a first force to a first portion of the seam and a second force less than the first force to a second portion of the seam when an inflating airbag contacts the seam.

At least some embodiments of the present invention may include a method for producing an airbag panel for a vehicle airbag system having an inflatable airbag and an inflator operable to inflate the airbag. The method may include attaching a first edge of a first panel portion to a trim material of the vehicle to form a seam. A second edge of a second panel portion may be attached to the trim material and to the first edge. At least one of the first panel portion or the second panel portion may include a force-concentrating feature having a configuration that causes a greater force to be applied to a portion of the seam than is applied to a second portion of the seam.

### BRIEF DESCRIPTION OF THE DRAWINGS

FIG. 1 shows a cross section of a portion of a vehicle seat, including an airbag and an airbag panel in accordance with at least some embodiments of the present invention;

FIG. 2 shows an airbag panel in accordance with at least some embodiments of the present invention having linear openings disposed directly across from each other on opposite sides of a trim seam;

FIG. 3 shows an airbag panel in accordance with at least some embodiments of the present invention having linear openings disposed in an offset pattern across from each other on opposite sides of a trim seam;

FIG. 4 shows an airbag panel in accordance with at least some embodiments of the present invention having a first portion with a first edge attached to a second portion with a second edge having a length that is less than a length of the first edge;

FIG. 5 shows an airbag panel in accordance with at least some embodiments of the present invention having pairs of openings configured to direct a tear force toward a small portion of a trim seam; and

FIG. 6 shows details of a portion of an airbag panel such as illustrated in FIG. 5.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

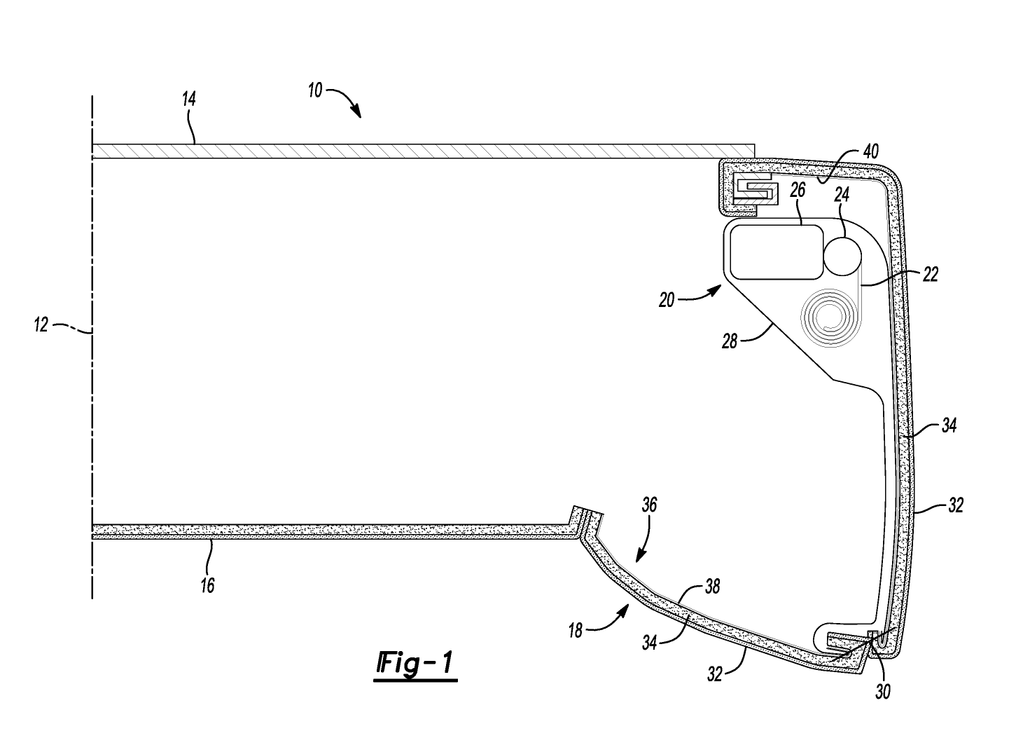

FIG. 1 shows a top-down view of a cross section of a portion of the vehicle seat 10. The dashed line 12 shows a midline of the vehicle seat 10, which includes a back panel 14 and a front side 16 of the seatback. A left bolster portion 18 includes an airbag system 20. The airbag system 20 includes an inflatable airbag 22 and an inflator 24 operable to inflate the airbag 22. The airbag system 20 is attached to a portion of the vehicle seat frame 26. A deployment chute 28 is used to help concentrate the force of the inflating airbag 22 toward a tear seam 30 disposed in the bolster 18. The outside of the bolster 18 includes a trim material 32, which may be cloth, vinyl, leather, or some other suitable trim material for the seat 10. In the vehicle seat 10 shown in FIG. 1, a foam layer 34 is disposed just below the trim material 32.

Also included as part of the airbag system 20 is a reinforcement airbag panel 36 having a first portion 38 and a second portion 40. The reinforcement panel 36 may be made from any material effective to achieve the desired functionality; however, it may be conveniently made from the same material as the deployment chute 28. As shown in FIG. 1, the first and second portions 38, 40 are disposed around at least a portion of the airbag 22, and, as explained in more detail below, help to provide a system whereby the tear seam 30 can be strong enough to withstand normal wear and tear, but will still open as required to facilitate proper deployment of the airbag 22. In the embodiment illustrated in FIG. 1, the two portions 38, 40 of the airbag panel 36 are attached to each other at the tear seam 30. Also attached at the seam 30 is the deployment chute 28, the trim cover material 32 and the foam 34. It is understood that airbag panels in accordance with embodiments of the present invention may be used with airbag systems having different configurations from the one shown in FIG. 1, and may be used in vehicle interior systems other than seating systems.

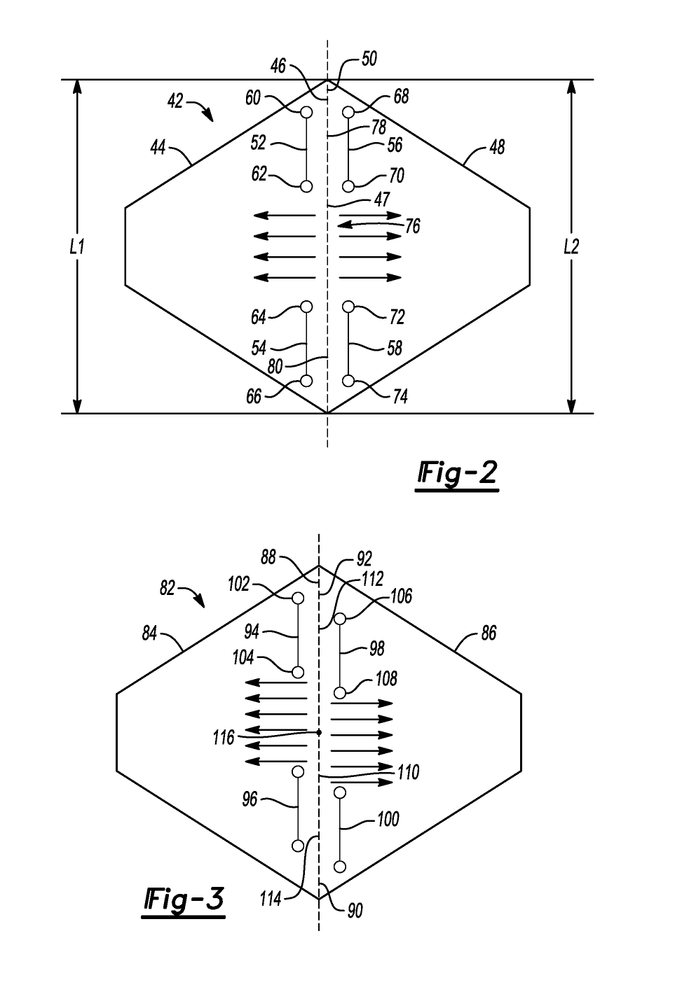

FIG. 2 shows an airbag panel 42 in accordance with an embodiment of the present invention. The airbag panel 42 includes a first portion 44 having a first edge 46 configured to be attached to a trim material of a vehicle to form a seam—for example, the trim material 32 and the seam 30 shown in FIG. 1. The airbag panel 42 also includes a second portion 48 having a second edge 50 configured to be attached to the first edge 46, and which may also be attached to a trim material of the vehicle—for example, the trim material 32 used in the vehicle seat 10 shown in FIG. 1. Although the airbag panel 42 is not shown in FIG. 2 as being attached to a trim material, the attachment of the first panel portion 44 to the second panel portion 48 forms a seam 47, which is understood to include the trim material when the airbag panel 42 is installed in the interior of a vehicle.

As shown in FIG. 2, the first edge 46 is configured to be attached to vehicle trim material along a first length (L1) to form the seam 47. Similarly, the second edge 50 is configured to be attached to the first edge 46 and the trim material along the second length (L2). In the embodiment shown in FIG. 2, the first and second lengths, L1, L2 are at least substantially the same and coincide with the length of the seam 47; however, as explained in more detail below, in other embodiments these lengths may not be the same.

The airbag panel 42 also includes several force-concentrating features, which in the embodiment shown in FIG. 2 are configured as openings, and in particular linear openings 52, 54 disposed through the first portion 44, and linear openings 56, 58 disposed through the second portion 48. Each of the linear openings 52-58 includes stress-relief geometry at each of its ends. In the embodiment shown in FIG. 2, these are circular holes 60, 62 for the opening 52; circular holes 64, 66 for the opening 54; circular holes 68, 70 for the opening 56; and circular holes 72, 74 for the opening 58. These force-concentrating features may be made, for example, with an upholstery cutting machine, which utilizes a knife to slice the openings 52-58, and punches to create the circular holes 60-74 at either end of the knife slices.

As shown in FIG. 2, each of the openings 52, 54 is oriented in a direction that is generally parallel to the first edge 46, and the openings 56, 58 are both oriented in a direction that is generally parallel to the second edge 50. In the embodiment shown in FIG. 2, each of the openings 52-58 have substantially the same length, and the openings 52, 54 in the first portion 44 are disposed directly opposite the openings 56, 58, respectively, in the second portion 48. The openings 52-58 provide force-concentrating features which tend to concentrate the force of a deploying airbag toward a middle section 76 of the seam 47. In other embodiments of the invention, openings or other force-concentrating features may be provided to concentrate the force toward a different section of the seam—i.e., not necessarily toward the middle of the seam.

The direction arrows shown in FIG. 2 represent the tensile forces that will be experienced by the airbag panel 42, and in particular the seam 47, when an airbag is deployed. When the airbag deploys, the openings 52-58 will expand and the material directly around them will deform. This reduces the energy of the airbag experienced by sections 78, 80 of the seam 47, which are respectively disposed between the openings 52, 56 and 54, 58. In contrast, the material around the middle section 76 of the seam has no openings, and therefore this section experiences the full force of the airbag deployment. This allows a tear seam and a trim material to be made using a much stronger stitch while still allowing proper deployment of the airbag when it inflates. In general, the force-concentrating features 52-58 cause a greater force to be applied to the middle section 76 of the seam 47 than is applied to the other sections 78, 80 of the seam 47.

Threads used in stitching a seam—such as the seam 30 shown in FIG. 1 or the seam 47 shown in FIG. 2—may be designated by a “T” number, such as T70, T90, etc. The higher the “T” number, the heavier the thread. In some situations, a top thread and a bottom thread may both be designated, so the top and bottom may be designated together as T70/30, T70/70, or T90/90 just to name a few. In at least some tests using a configuration similar to that shown in FIG. 2, the peak load required to rupture a test seam having a T70/70 thread was approximately 400 Newtons (N); whereas, without the force-concentrating features the same seam with the same thread required over 900 N to rupture. Even a seam made with a much weaker T70/30 thread still required over 600 N of force to rupture when it was not configured with the force-concentrating features, such as those described above.

FIG. 3 shows an airbag panel 82 in accordance with at least some embodiments of the present invention. The airbag panel 82 includes a first panel portion 84 and the second panel portion 86. The first panel portion 84 includes a first edge 88 attached to a second edge 90 of the second panel portion 86 to form a seam 92. As explained above, it is contemplated that the seam 92 will also be formed as part of a trim material of the vehicle interior—for example the trim material 32 and the seam 30 illustrated in FIG. 1. The first panel portion 84 includes force-concentrating features 94, 96, and the second panel portion 86 includes force concentrating features 98, 100. Each of the force-concentrating features 94-100 are configured as openings, similar to the openings 52-58 shown in FIG. 2. In particular, the openings 94, 96 are generally parallel to the first edge 88, and the openings 98, 100 are generally parallel to the second edge 90. Similar to the configuration shown in FIG. 2, the first and second edges 88, 90 have substantially the same length, which coincides with the length of the seam 92.

As shown in FIG. 3, the opening 94 includes two ends 102, 104. Similarly, the opening 98 includes two ends 106, 108. Unlike the configuration illustrated in FIG. 2, where the openings 52, 54 in the first panel portion 44 were disposed directly opposite on the other side of the seam 47 from the openings 56, 58 of the second panel portion 48, a different configuration is provided for the airbag panel 82. In particular, each of the ends 102, 104 of the opening 94 are offset from the two corresponding ends 106, 108 of the opening 98 on the other side of the seam 92. This configuration also concentrates the force on the seam 92 such that a greater force will be experienced by a middle section 110 of the seam 92 than is experienced by the sections 112, 114. With the configuration shown in FIG. 3, a virtual tear point 116 may be identified on the seam 92 just at the point at which the concentrated forces from the first panel portion 84 overlap with those of the second panel portion 86.

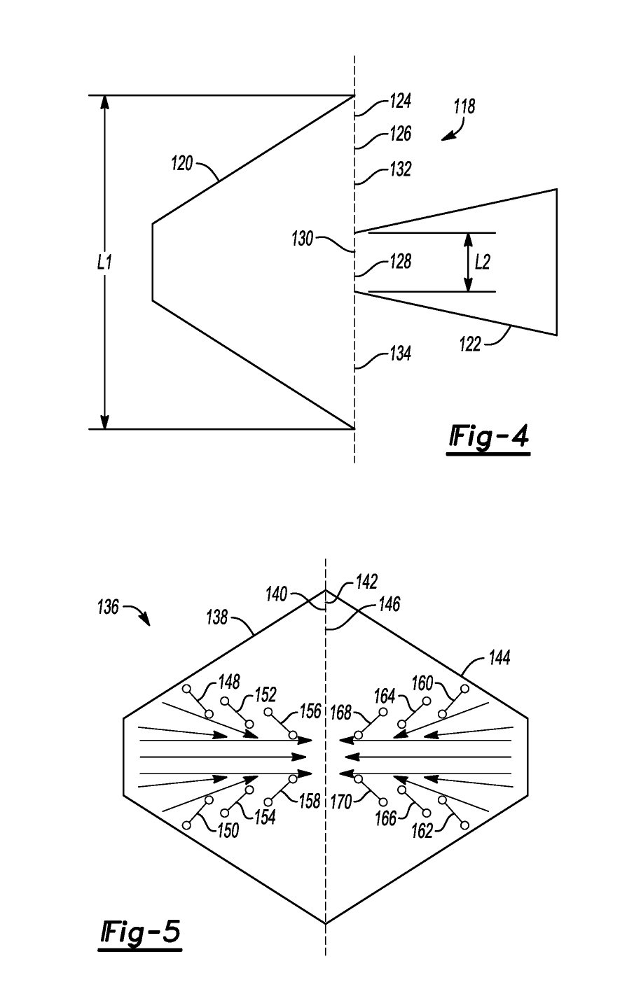

FIG. 4 shows an airbag panel 118 in accordance with at least some embodiments of the present invention. The airbag panel 118 includes a first panel portion 120 and a second panel portion 122. The first panel portion 120 includes a first edge 124 configured to be attached to a trim material—such as the trim material 32 shown in FIG. 1—to form a seam 126. The second panel portion 122 includes a second edge 128 configured to be attached to the first edge 124. In the embodiment shown in FIG. 4, the length (L1) of the first edge 124 is substantially greater than the length (L2) of the second edge 128. Thus, the second edge 128 is attached to the first edge 124 along only a section 130 of the seam 126, although it is understood that the associated trim material may be attached along the entire length of the seam 126. The difference in the lengths of the edges 124, 128 effects a force-concentrating feature for the airbag panel 118. In particular, all, or substantially all, of the force of the inflating airbag is concentrated along the section 130 of the seam 126. This means that other sections 132, 134 of the seam 126 will experience less stress than the section 130 when the airbag inflates, and, as described above, a stronger thread can be used to form the seam 126 than might otherwise be available without the force-concentrating feature of the different lengths of attachment.

FIG. 5 shows an airbag panel 136 in accordance with at least some embodiments of the present invention. The airbag panel 136 includes a first panel portion 138 having a first edge 140 configured to be attached to a trim material to form a seam 142. The airbag panel 136 also includes a second panel portion 144 having a second edge 146 configured to be attached to the first edge 140 along a length of the seam 146. In the embodiment shown in FIG. 5, the airbag panel 136 includes a number of force concentrating features 148, 150, 152, 154, 156, 158, each associated with the first panel portion 138. Similarly, the second panel portion 144 includes force-concentrating features 160, 162, 164, 166, 168, 170.

As shown in FIG. 5, each of the force-concentrating features are configured as openings through one of the panel portions 138, 144. In addition, the openings are configured in pairs: 148, 150 making up the two elements of a first pair; 152, 154 being the two elements of a second pair; and 156, 158 the two elements of a third pair, with each of these three pairs being disposed in the first panel portion 138. A similar configuration is shown for the second panel portion 144, which includes pairs 160, 162; 164, 166; and 168, 170. In each of the two panel portions 138, 144 the elements of each pair are disposed increasingly close to each other as the pairs get closer to the edge of their respective panel portion.

More specifically, in the first panel portion 138, the elements 148, 150 of the first pair of openings are farther away from each other than the elements 156, 158 of the third pair, which is the closest set of openings to the first edge 140. The same is true for the openings in the second panel portion 144. As illustrated by the force-direction arrows in FIG. 5, this configuration provides an increasingly concentrated force pattern, somewhat analogous to a nozzle. In addition, this configuration of openings may provide an opportunity to use openings of a shorter length.

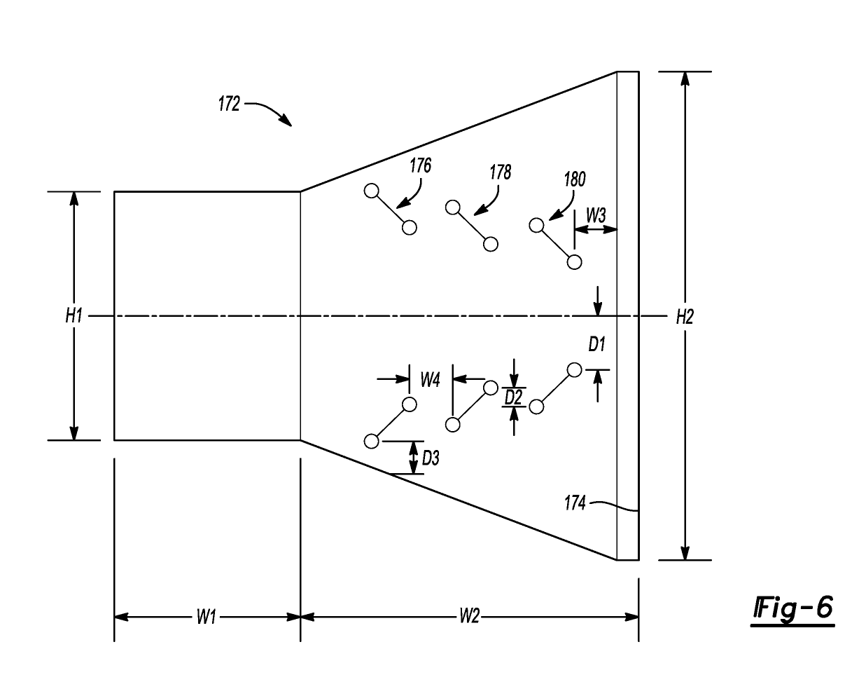

FIG. 6 shows one portion 172 of an airbag panel in accordance with at least some embodiments of the present invention. The panel portion 172 may be part of the configuration such as the airbag panel 136 shown in FIG. 5. The panel portion 172 includes an edge 174 configured to be attached to a trim material to form a seam, such as described above. The panel portion 172 also includes force-concentrating features, which are configured as pairs of openings disposed through the panel portion material. In at least some embodiments, the heights (H1), (H2), may be approximately 100 millimeters (mm) and 200 mm, respectively. The overall widths (W1), (W2) may be approximately 75 mm and 125 mm, respectively.

FIG. 6 also provides some additional dimensions for one possible configuration of the airbag panel 172. As shown in FIG. 6, there are three pairs of openings 176, 178, 180. As described above with regard to the airbag panel 136 shown in FIG. 5, each of the three pairs 176, 178, 180 includes elements that are increasingly close to each other as the pairs get closer to the edge 174 of the panel portion 172. In the embodiment shown in FIG. 6, each of the openings is disposed at an angle of approximately 45° from the edge 174 of the panel portion 172. The first distance (D1) may be approximately 40 mm, while the other two distances (D2), (D3) may each be approximately 10 mm. The two widths associated with positioning the openings (W3), (W4) may each be approximately 15 mm.

Although not shown with a dimension variable, each of the openings in the three pairs 176, 178, 180 may have a length of approximately 25 mm. It is understood that these dimensions provide an example of how an airbag panel may be configured for a particular vehicle in a particular application; of course, different vehicle lines and different applications even within the same vehicle may use airbag panels in accordance with embodiments of the present invention having dimensions that are different from the ones provided in this example.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An airbag panel for a vehicle airbag system having an inflatable airbag and an inflator operable to inflate the airbag, the airbag panel comprising:
a first portion including a first edge configured to be attached to a trim material of the vehicle to form a seam;
a second portion including a second edge configured to be attached to the first edge and the trim material along at least a portion of the seam; and
a force-concentrating feature that causes a greater force to be applied to a first section of the seam than is applied to a second section of the seam when the first and second portions are attached to each other, are disposed around at least a portion of an airbag, and an inflator is activated to inflate the airbag.

2. The airbag panel of claim 1, wherein the second edge has a length that is less than a length of the first edge such that the second edge is configured to be attached to the first section only of the seam to effect the force-concentrating feature.

3. The airbag panel of claim 1, further comprising a plurality of the force-concentrating features, each of the force-concentrating features being configured as an opening disposed through at least one of the first or second portions.

4. The airbag panel of claim 3, wherein at least some of the openings are disposed in at least one of the first portion or the second portion in pairs having elements that are disposed increasingly close to each other as the pairs get closer to a respective first edge or second edge.

5. The airbag panel of claim 3, wherein each of the force-concentrating features is configured as a linear opening having a stress-relief geometry at each end.

6. The airbag panel of claim 3, wherein each of the force-concentrating features is configured as a linear opening, and a first opening of the linear openings is disposed through the first portion and a second opening of the linear openings is disposed in through the second portion.

7. The airbag panel of claim 6, wherein the first opening is disposed through the first portion in a direction generally parallel to the first edge, and the second opening is disposed through the second portion in a direction generally parallel to the second edge.

8. The airbag panel of claim 7, wherein the first opening and the second opening have substantially the same length and are disposed directly opposite each other when the second edge is attached to the first edge.

9. The airbag panel of claim 7, wherein the first opening has two ends that are each offset from two corresponding ends of the second opening when the second edge is attached to the first edge.

10. An airbag panel for a vehicle airbag system having an inflatable airbag and an inflator operable to inflate the airbag, the airbag panel comprising:
a first edge configured to be attached to a trim material in a vehicle interior along a first length to form a seam;
a second edge configured to be attached to the first edge and the trim material along a second length; and
at least one force-concentrating feature associated with at least one of the first edge or the second edge, and configured to effect application of a first force to a first portion of the seam and a second force less than the first force to a second portion of the seam when an inflating airbag contacts the seam.

11. The airbag panel of claim 10, wherein the at least one force-concentrating feature includes the second length being less than the first length such that when the second edge is attached to the first edge along the second length, a length of attachment is less than the first length.

12. The airbag panel of claim 10, wherein the at least one force-concentrating feature is configured as an opening disposed proximate at least one of the first edge or the second edge.

13. The airbag panel of claim 10, wherein the at least one force-concentrating feature includes a plurality of openings, at least one of the openings being disposed on one side of the seam and at least one other of the openings being disposed on an other side of the seam.

14. The airbag panel of claim 13, wherein each of the at least one of the openings is disposed directly across the seam from a respective one of the at least one other of the openings.

15. The airbag panel of claim 13, wherein each of the at least one of the openings is offset from a respective one of the at least one other of the openings.

16. The airbag panel of claim 10, wherein the at least one force-concentrating feature includes a plurality of openings, at least some of the openings being configured in pairs, each of the pairs having a first opening and a second opening, and wherein the first opening and second opening of each pairs are disposed closer to each other as the pairs get closer to the seam.

17. The airbag panel of claim 10, wherein the at least one force-concentrating feature is configured as a linear opening having a stress-relief geometry at each end.

18. A method for producing an airbag panel for vehicle airbag system having an inflatable airbag and an inflator operable to inflate the airbag, the method comprising:
attaching a first edge of a first panel portion to a trim material of the vehicle to form a seam;
attaching a second edge of a second panel portion to the trim material; and
attaching the second edge of the second panel portion to the first edge, at least one of the first panel portion or the second panel portion including a force-concentrating feature having a configuration that causes a greater force to be applied to a first portion of the seam than is applied to a second portion of the seam.

19. The method of claim 18, wherein the second edge has a length that is less than a length of the first edge.

20. The method of claim 18, wherein the first edge has a length that is approximately the same as a length of the second edge, and wherein the force-concentrating feature includes at least one opening in at least one of the first panel portion or the second panel portion.
